(19) United States
(12) Patent Application Publication
(10) Pub. No.: US 2011/0135832 A1
(43) Pub. Date: Jun. 9, 2011

(54) METHOD AND COMPOSITION FOR REFINISH COATINGS

(75) Inventors: Matthew T. Lane, Bowling Green, OH (US); Barry B. Gott, Sylvania, OH (US)

(73) Assignee: BASF Coatings AG, Muenster (DE)

(21) Appl. No.: 12/631,410

(22) Filed: Dec. 4, 2009

(51) Int. Cl. B05D 3/02; B65D 85/00

(52) U.S. Cl. 427/385.5; 206/525

(57) ABSTRACT

A refinish, multi-component coating composition includes a first package including a hydroxyl-functional polymer, a second package containing a polyisocyanate crosslinker, and, optionally, one or more reducers. The refinish composition further includes from about 1 to about 4.5 percent by weight, based on total nonvolatile vehicle weight, of a melamine resin that is substantially unreactive toward the hydroxyl-functional polymer at temperatures up to about 60° C. The melamine resin may be included in the first package, the second package, a reducer, a plurality of reducers, or a combination of these. In one embodiment, the refinish, multi-component coating composition is a two-component clearcoat coating composition having clear or transparent first package. In another embodiment, the refinish, multi-component coating composition is a multi-component monocoat coating composition having a plurality of differently colored bases containing pigment and hydroxyl-functional polymer as first components or packages, one or more of which is combined with the second package with polyisocyanates just prior to application. A method of refinishing a substrate includes combining the first package (whether clear or one or more bases), the second package, and optionally one or more reducers to form a refinish coating composition mixture including the melamine resin, applying the refinish coating composition mixture to a desired area of the substrate, and curing the applied composition mixture to form a cured refinish coating layer from the applied refinish coating composition mixture. Also provided is the cured refinish coating and the article (particularly, an automotive vehicle or vehicle trailer) having on it the cured refinish coating.

### FIELD OF THE INVENTION

The present invention relates to automotive refinish compositions, to methods for preparing and using such compositions, to refinish coatings on a substrate, and to articles such as automotive vehicles with refinish coatings on them.

### INTRODUCTION TO THE DISCLOSURE

Automotive topcoat finishes include basecoat/clearcoat topcoats, in which the topcoat is applied in two layers, a first layer of a pigmented basecoat composition and a second layer of a clearcoat composition, as well as monocoat topcoats, which are one-layer, pigmented, glossy topcoats. Basecoat/clearcoat coatings are desirable for their high level of gloss and depth of color. In addition, basecoats having special effect pigments, e.g., flake pigments such as metallic and pearlescent pigment, can achieve excellent gonioapparent effect in basecoat coatings.

Polyurethane clearcoat and monocoat systems have been widely used for many years for refinish coatings. These systems contain hydroxyl-functional resins that cure by reaction with polyisocyanates to form polyurethanes with excellent film properties including durability, toughness, and solvent resistance. In automotive refinish coating compositions, the polyisocyanates are not blocked so that the reaction with the hydroxyl groups will take place within a reasonable amount of time without heating or with heating at low temperatures of perhaps up to 150° F. Given the reactivity between the unblocked polyisocyanate and the hydroxyl-functional polyol under typical storage conditions, these materials are segregated into separately stored components until mixing just shortly before application of the coating composition to the substrate to be coated. This type of coating composition, in which the materials that react to cure the coating (resin and crosslinker) are segregated in separately stored components designed to be combined just before application, is referred to in the art as a “two-component” or “multi-component,” “two-package,” or “2K” coating composition. Automotive refinish clearcoats may include other separately stored components, such as reducers used to provide desirable application characteristics for the particular application conditions (e.g., a fast reducer for cold weather, a slower reducer for hot weather). For monocoat systems, a multi-component or multi-package coating composition includes multiple, differently colored bases containing pigment and hydroxyl-functional resin, one or more of which is combined with a polyisocyanates crosslinker component and, optionally, a reducer or other component just before application.

Once applied and cured, the outer coating layer, whether it is a clearcoat layer or a pigmented monocoat layer, should be resistant to weathering degradation (e.g., retain its gloss on exposure to sunlight) and resistant to scratching and marring, which also can detract from the appearance of the coated vehicle.

### SUMMARY OF THE INVENTION

A refinish, multi-component coating composition includes a first package including a hydroxyl-functional polymer, a second package containing a polyisocyanate crosslinker, and, optionally, one or more reducers. The refinish composition further includes from about 1 to about 4.5 percent by weight, based on total nonvolatile vehicle weight, of a melamine resin that is substantially unreactive toward the hydroxyl-functional polymer at temperatures up to about 60° C. “Polymer” and “resin” are used interchangeably in this disclosure. “Nonvolatile vehicle” or “vehicle” in the context of the coating composition refers to the combination of all film-forming components of the coating composition. The “total nonvolatile vehicle weight” refers to nonvolatile vehicle in a refinish coating composition mixture of the packages or components combined for application. Preferably, no more than about 50% by weight of the melamine resin molecules react with the hydroxyl-functional polymer during cure. The refinish composition is free of strong acid catalysts. In certain embodiments, the refinish composition may include a carboxylic acid-functional polymer, but such is a polymer is not considered to be a strong acid catalyst.

The melamine resin may be included in the first package, the second package, a reducer, or a combination of these. In one embodiment, the refinish, multi-component coating composition is a two-component clearcoat coating composition having clear or transparent first package. In another embodiment, the refinish, multi-component coating composition is a multi-component monocoat coating composition having a plurality of differently colored bases containing pigment and hydroxyl-functional polymer as first components or packages, one or more of which is combined with the second package with polyisocyanates just prior to application.

A method of refinishing a substrate includes combining the first package (whether clear or one or more bases), the second package, and optionally one or more reducers to form a refinish coating composition mixture including the melamine resin, applying the refinish coating composition mixture to a desired area of the substrate, and curing the applied composition mixture to form a cured refinish coating layer from the applied refinish coating composition mixture. The refinish coating composition mixture has an unexpectedly extended pot life and provides longer melt-in times. Also provided is the cured refinish coating and the article (particularly, an automotive vehicle or vehicle trailer) having on it the cured refinish coating. The cured refinish coating provides several unexpected, advantageous properties, including some “self-healing” characteristics in which small scratches and scuffs in the finish disappear with time. In addition, the refinish coating has improved resistance to degradation as demonstrated by higher gloss retention after standard accelerated weathering tests.

“A,” “an,” “the,” “at least one,” and “one or more” are used interchangeably to indicate that at least one of the item is present; a plurality of such items may be present. Other than in the working examples provides at the end of the detailed description, all numerical values of parameters (e.g., of quantities or conditions) in this specification, including the appended claims, are to be understood as being modified in all instances by the term “about” whether or not “about” actually appears before the numerical value. “About” indicates that the stated numerical value allows some slight imprecision (with some approach to exactness in the value; approximately or reasonably close to the value; nearly). If the imprecision provided by “about” is not otherwise understood in the art with this ordinary meaning, then “about” as used herein indicates at least variations that may arise from ordinary methods of measuring and using such parameters. In addition, disclosure of ranges includes disclosure of all values and further divided ranges within the entire range.

Further areas of applicability will become apparent from the description provided herein. It should be understood that the description and specific examples are intended for purposes of illustration only and are not intended to limit the scope of the present disclosure.

### DETAILED DESCRIPTION OF THE INVENTION

The following description is merely exemplary in nature and is not intended to limit the aspects of the disclosed invention, its application, or its uses.

A refinish, two-component or multi-component coating composition includes a first component package including a polyol resin or polymer. The polymeric polyol may be a polyester polyol, a polyether polyol, a polycarbonate polyol, or a hydroxyl-functional acrylic polymer. Suitable hydroxyl group-containing resins may have an OH number in the range from about 20 to about 360 mg KOH/g. In certain embodiments, the hydroxyl number may be from 40 to 200 mg KOH/g. Suitable polymeric polyols may have a number average molecular weight of about 800 to about 50,000. In some embodiments, polymeric polyols having a number average molecular weight of from about 5,000 to about 30,000 may be used.

Suitable hydroxyl-functional acrylic resins may be prepared by polymerizing one or more hydroxyl-functional, ethylenically unsaturated monomers with one or more other ethylenically unsaturated monomers. Suitable examples of hydroxy-functional ethylenically unsaturated monomers include hydroxy alkyl esters of acrylic or methacrylic acid. (In the context of describing the present invention, the term “(meth)acrylate” will be used to indicate that both the methacrylate and acrylate esters are included.) Nonlimiting examples of hydroxyl-functional monomers include hydroxyethyl (meth)acrylate, hydroxypropyl (meth)acrylates, hydroxybutyl (meth)acrylates, hydroxyhexyl (meth)acrylates, other hydroxyalkyl (meth)acrylates having branched or linear alkyl groups of up to about 10 carbons, and mixtures of these. ε-Caprolactone esters of these hydroxyl-functional monomers may also be used. The hydroxyl groups may also be esterified with ε-caprolactone following polymerization. Generally, at least about 5% by weight hydroxyl-functional monomer is included in the polymer. Example embodiments of the invention include up to about 15% by weight hydroxyl-functional monomer in the polymer. In certain embodiments, a hydroxyl-functional acrylic polymer polymerized from hydroxyethyl (meth)acrylate, hydroxypropyl (meth)acrylates, and mixtures of these may be used in the first component. The person skilled in the art will appreciate that hydroxyl groups can be generated by other means, such as, for example, the ring opening of a glycidyl group, for example from glycidyl methacrylate, by an organic acid or an amine. Hydroxyl functionality may also be introduced through thio-alcohol compounds, including, without limitation, 3-mercapto-1-propanol, 3-mercapto-2-butanol, 11-mercapto-1-undecanol, 1-mercapto-2-propanol, 2-mercaptoethanol, 6-mercapto-1-hexanol, 2-mercaptobenzyl alcohol, 3-mercapto-1,2-propanediol, 4-mercapto-1-butanol, and combinations of these. Any of these methods may be used to prepare a useful hydroxyl-functional acrylic polymer.

Examples of suitable comonomers that may be polymerized along with a hydroxyl-functional, ethylenically unsaturated monomer include, without limitation, acrylic acid, methacrylic acid, and crotonic acid; esters, nitriles, and amides of acrylic acid, methacrylic acid, and crotonic acid; vinyl esters, vinyl ethers, vinyl ketones, vinyl amides, and aromatic and cycloaliphatic vinyl compounds. Representative examples include, without limitation, acrylic and methacrylic acid amides and aminoalkyl amides; acrylonitrile and methacrylonitriles; esters of acrylic and methacrylic acid, particularly those with saturated aliphatic and cycloaliphatic alcohols containing 1 to 20 carbon atoms such as methyl, ethyl, propyl, butyl, 2-ethylhexyl, isobutyl, isopropyl, cyclohexyl, tetrahydrofurfuryl, isobornyl, 2-tert-butyl cyclohexyl, 4-tert-butyl cyclohexyl, acrylates and methacrylates; unsaturated dialkanoic acids and anhydrides such as fumaric, maleic, itaconic acids and anhydrides and their mono- and diesters with alcohols such as methanol, ethanol, propanol, isopropanol, butanol, isobutanol, and tert-butanol, like maleic anhydride, maleic acid dimethyl ester and maleic acid monohexyl ester; vinyl acetate, vinyl propionate, vinyl ethyl ether, and vinyl ethyl ketone; styrene, α-methyl styrene, vinyl toluene, 2-vinyl pyrrolidone, and p-tert-butylstyrene. The co-monomers may be used in any desired combination to obtain desired coating properties.

The acrylic polymer may be prepared using conventional techniques, such as by heating the monomers in the presence of a polymerization initiating agent and optionally a chain transfer agent. The polymerization is preferably carried out in solution, although it is also possible to polymerize the acrylic polymer in bulk or as an emulsion.

Typical initiators are organic peroxides such as dialkyl peroxides such as di-t-butyl peroxide, peroxyesters such as t-butyl peroxy 2-ethylhexanoate, and t-butyl peracetate, peroxydicarbonates, diacyl peroxides, hydroperoxides such as t-butyl hydroperoxide, and peroxyketals; azo compounds such as 2,2′azobis(2-methylbutanenitrile) and 1,1′-azobis(cyclohexanecarbonitrile); and combinations of these. Typical chain transfer agents are mercaptans such as octyl mercaptan, n- or tert-dodecyl mercaptan; halogenated compounds, thiosalicylic acid, mercaptoacetic acid, mercaptoethanol and the other thiol alcohols already mentioned, and dimeric alpha-methyl styrene.

The reaction is usually carried out at temperatures from about 20° C. to about 200° C. The reaction may conveniently be done at the temperature at which the solvent or solvent mixture refluxes, although with proper control a temperature below the reflux may be maintained. The initiator should be chosen to match the temperature at which the reaction is carried out, so that the half-life of the initiator at that temperature should preferably be no more than about thirty minutes. Further details of addition polymerization generally and of polymerization of mixtures including (meth)acrylate monomers is readily available in the polymer art.

Film-forming polyesters are formed by condensation polymerization of polycarboxylic acids or anhydrides of such acids with polyols and/or epoxides. Useful polyesters are linear, formed by reaction products of dicarboxylic acids and diols or diepoxides, or have a limited amount of branching, introduced by a reactant with a functionality greater than two, optionally in combination with a monofunctional reactant. Preferably, an excess of equivalents of the polyol is used so that the polyester has terminal hydroxyl groups. Alternatively, if an excess of equivalents of acid functionality is used so that an acid-terminated polyester is formed, the acid groups can be reacted with a compound that has one or more hydroxyl groups and one or more groups reactive with acid groups, such as a triol, tetraol, and the like.

The polycarboxylic acids may include any of aromatic, aliphatic and cycloaliphatic polycarboxylic acids. Examples of useful dicarboxylic acids and anhydrides include, without limitation, oxalic acid, malonic acid, succinic acid, glutaric acid, adipic acid, maleic acid, pimelic acid, terephthalic acid, isophthalic acid, phthalic acid, tetrahydrophthalic acid, hexahydrophthalic acid, fumaric acid, azelaic acid, sebacic acid, dimer fatty acid, benzenetricarboxylic acids, methyl hexahydrophthalic acid, glutamic acid, the anhydrides of these acids, and the like, as well as combinations of these. The cycloaliphatic polycarboxylic acids may be employed either in their cis or in their trans form or as a mixture of the two forms. Also suitable are the esterifiable derivatives of the above polycarboxylic acids, for example their esters with aliphatic alcohols having one to four carbon atoms.

Optionally, minor amounts of monocarboxylic acids can also be used with the polycarboxylic acids, particularly when higher functional (e.g., tri- or tetracarboxylic) acids are included. Examples of useful monocarboxylic acids are benzoic acid, tert-butylbenzoic acid, lauric acid, isonoanoic acid and fatty acids of naturally occurring oils.

Examples of polyols suitable for the preparation of the polyester polyol include, without limitation, 1,4-butanediol, 1,3-butanediol, 2,3-butanediol, 1,2,4-butanetriol, 1,6-hexanediol, 1,2,6-hexanetriol, neopentyl glycol, ethylene glycol, propylene glycol, pentaerythritol, oligomers of these such as diethylene glycol, triethylene glycol, dipropylene glycol, and dipentaerythritol, glycerol, trimethylolpropane, cylcohexanedimethanols, 2-methyl-2-ethyl-1,3-propanediol, 2-ethyl-1,3-hexanediol, 1,5-pentanediol, thiodiglycol, 1,3-propanediol, 2,2,4-trimethyl-1,3-pentanediol, cyclohexanediols, mannitol, sorbitol, and combinations of these. Compounds having both acid and alcohol groups may be included, non-limiting examples of which are dimethylolpropionic acid, ricinoleic acid, and 12-hydroxylstearic acid. The polyol component may also include, if desired, minor amounts of monohydric alcohols, for example butanol, octanol, lauryl alcohol, and ethoxylated and propoxylated phenols. Polyesters may also be prepared using lactones such as ε-caprolactone and δ-butyrolactone or diols thereof, for example the reaction product of ε-caprolactone and a diol such as ethylene glycol. Polylactone polyol can be used as a reactant in the polyester synthesis. In another embodiment, a polyester polyol can be modified by reaction with a lactone after the polyester polymerization.

Techniques for preparing polyesters are well known. The reaction is conventionally carried out at temperatures of between 180 and 280° C. in the presence, if desired, of an appropriate esterification catalyst, for example lithium octanoate, dibutyl tin oxide, dibutyltin dilaurate, para-toluene sulfonic acid and the like.

A film-forming polyurethane can be synthesized by reacting a polyol, preferably a diol, with a polyisocyanate, preferably a diisocyanate. The polyisocyanate can be an aliphatic polyisocyanate, including a cycloaliphatic polyisocyanate, or an aromatic polyisocyanate. The term “polyisocyanate” as used herein refers to any compound having a plurality of isocyanate functional groups on average per molecules. Polyisocyanates encompass, for example, monomeric polyisocyanates including monomeric diisocyanates and triisocyanates, biurets and isocyanurates of monomeric polyisocyanates, extended poly-functional isocyanates formed by reacting one mole of a diol with two moles of a diisocyanate or by reacting one mole of a triol with three moles of a diisocyanate, and the like. Aliphatic polyisocyanates are preferred when the coating composition is an automotive topcoat composition. Useful examples include, without limitation, ethylene diisocyanate, 1,2-diisocyanatopropane, 1,3-diisocyanatopropane, 1,4-butylene diisocyanate, lysine diisocyanate, 1,4-methylene bis(cyclohexyl isocyanate), isophorone diisocyanate, toluene diisocyanate, the isocyanurate of toluene diisocyanate, diphenylmethane 4,4′-diisocyanate, the isocyanurate of diphenylmethane 4,4′-diisocyanate, methylenebis-4,4′-isocyanatocyclohexane, isophorone diisocyanate, the isocyanurate of isophorone diisocyanate, 1,6-hexamethylene diisocyanate, the isocyanurate of 1,6-hexamethylene diisocyanate, 1,4-cyclohexane diisocyanate, p-phenylene diisocyanate, triphenylmethane 4,4′,4″-triisocyanate, tetramethyl xylene diisocyanate, and meta-xylene diisocyanate.

The polyol can be the same as the polyols described above for the preparation of polyesters. In a preferred embodiment, at least one oligomeric or polymeric polyol is used to prepare the polyurethane. Non-limiting examples of oligomeric or polymeric polyols are polyester polyols and polyether polyols. Polyester polyols or polyether polyols used in the synthesis of a film-forming polyurethane typically have a number average molecular weight of about 400 to about 5000. A polyester polyol can be prepared as already described. Polyether polyols may be obtained by the alkoxylation of polyols (generally of monomeric polyols, but in certain embodiments the polyol that is alkyoxylated may be one of the acrylic polymer polyols and polyester polyols already described), water, organic polyamines having at least two N—H bonds, and mixtures of these. Preferred alkylene oxides for the alkoxylation reaction are ethylene oxide and/or propylene oxide, which may be used in the alkoxylation reaction alone, in admixture, or in any sequence.

Non-limiting examples of polyether polyols are polyalkylene ether polyols that include poly(oxytetraethylene) glycols, poly(oxy-1,2-propylene) glycols and poly(oxy-1,2-butylene) glycols. Also useful are polyether polyols formed from oxyalkylation of various polyols, for example, glycols such as ethylene glycol, 1,6-hexanediol, Bisphenol A and the like, or other higher polyols, such as trimethylolpropane, pentaerythritol and the like. Useful polyols of higher functionality can be made, for instance, by oxyalkylation of compounds such as sorbitol or sucrose. One commonly utilized oxyalkylation method is to react a polyol with an alkylene oxide, for example, ethylene or propylene oxide, in the presence of an acidic or basic catalyst.

Two general synthetic approaches may be utilized to prepare a linear polyurethane resin. A polyurethane having terminal hydroxy functionality can be obtained by reacting a diisocyanate and a diol in an OH:NCO equivalent ratio of greater than 1:1. In this case, the polyurethane resin formed will have terminal hydroxyl groups as a result of the equivalent excess of the polyol. Alternatively, the polyurethane may be formed by reacting diisocyanate and diol in an OH:NCO ratio of less than 1:1, thus forming a polyurethane having terminal isocyanate functionality, and then reacting the terminal isocyanate groups in a second step, sometimes called a capping step, with a compound having at least one group reactive with isocyanate functionality, which may be, for example, a hydroxyl group or a primary or secondary amine group, and at least one (or at least one additional) hydroxyl group or at least one group that can be converted into a hydroxyl group. Suitable capping agents include, without limitation, aminoalcohols such as ethanolamine and diethanolamine, solketal, diols such as neopentyl glycol, triols such as trimethylolpropane, and mixture of these. This method is useful for providing a plurality of hydroxyl groups at each end of the polymer. When a polyisocyanate or polyol of functionality greater than two is included, the polyurethane will have some branching. A monofunctional isocyanate or alcohol may then be added also for molecular weight control.

The first component package including the polyol resin or polymer generally includes other materials, such as solvent and conventional coating additives. When the refinish, multi-component coating composition is for a single stage topcoat, a plurality of first component packages will be included as color bases as part of a mixer system that may be combined in predetermined amounts to provide a refinish coating of a desired color. Each color base will include one or more pigments dispersed according to known methods in the art.

The refinish, multi-component coating composition includes a second package including a polyisocyanate. crosslinker. Examples of suitable polyisocyanate crosslinkers include, without limitation, alkylene polyisocyanates such as hexamethylene diisocyanate, 2,2,4- and/or 2,4,4-trimethylhexamethylene diisocyanate, dodecamethylene diisocyanate, 1,4-diisocyanatocyclohexane, 1-isocyanato-3,3,5-trimethyl-5-isocyanatomethylcyclohexane (isophorone diisocyanate), 2,4′- and/or 4,4′-diisocyanatodicyclohexylmethane, 3-isocyanato-methyl-3,5,5-trimethyl cyclohexyl isocyanate, aromatic polyisocyanates such as 2,4′- and/or 4,4′-diisocyanatodiphenylmethane, 2,4- and/or 2,6-diisocyanatotoluene, naphthylene diisocyanate, and mixtures of these polyisocyanates. Generally, polyisocyanates having three or more isocyanate groups are used; these may be derivatives or adducts of diisocyanates. Useful polyisocyanates may be obtained by reaction of an excess amount of an isocyanate with water, a polyol (for example, ethylene glycol, propylene glycol, 1,3-butylene glycol, neopentyl glycol, 2,2,4-trimethyl-1,3-pentane diol, hexamethylene glycol, cyclohexane dimethanol, hydrogenated bisphenol A, trimethylolpropane, trimethylolethane, 1,2,6-hexanetriol, glycerine, sorbitol or pentaerythritol), or by the reaction of the isocyanate with itself to give an isocyanurate. Examples include biuret-group-containing polyisocyanates, such as those described, for example, in U.S. Pat. No. 3,124,605 and U.S. Pat. No. 3,201,372 or DE-OS 1,101,394; isocyanurate-group-containing polyisocyanates, such as those described, for example, in U.S. Pat. No. 3,001,973, DE-PS 1,022,789, 1,222,067 and 1,027,394 and in DE-OS 1,929,034 and 2,004,048; urethane-group-containing polyisocyanates, such as those described, for example, in DE-OS 953,012, BE-PS 752,261 or U.S. Pat. Nos. 3,394,164 and 3,644,457; carbodiimide group-containing polyisocyanates, such as those described in DE-PS 1,092,007, U.S. Pat. No. 3,152,162 and DE-OS 2,504,400, 2,537,685 and 2,552,350; allophanate group-containing polyisocyanates, such as those described, for example, in GB-PS 994,890, BE-PS 761,626 and NL-OS 7,102,524; and uretdione group-containing polyisocyanates, such as those described in EP-A 0,377,177, each reference being incorporated herein by reference.

Certain embodiments of the second component package include one of aliphatic biurets and isocyanurates, such as the isocyanurates of hexamethylene diisocyanate and isophorone diisocyanate.

A third, optional package includes a reducing solvent, optionally a further resin or polymer, and optionally a catalyst for the isocyanate-hydroxyl curing reaction. The multi-component refinish composition may include multiple reducer packages, which may each be designed to be used under different weather conditions. For example, the multi-component refinish composition may include one reducer package having a relatively fast solvent for use in cold weather to speed evaporation of solvent from the applied coating layer, while a second reducer package has a relatively slow solvent for use in hot weather to allow the coating layer to flow out properly before all the solvent evaporates. In general, the solvent can be any organic solvent or solvents suitable for the binder materials. The solvent or solvents may be selected from aliphatic solvents or aromatic solvents, for example ketones, esters, acetates, toluene, xylene, aromatic hydrocarbon blends, or a combination of any of these. Generally, each of the first and second packages will also include one or more organic solvent.

The refinish composition further includes from about 1 to about 4.5 percent by weight, based on total nonvolatile vehicle weight, of a melamine resin that is substantially unreactive toward the hydroxyl-functional polymer at temperatures up to about 60° C. In various embodiments, the refinish composition includes at least about 1.5 percent by weight, based on total nonvolatile vehicle weight, of a melamine resin or at least about 2 percent by weight, based on total nonvolatile vehicle weight, of a melamine resin or up to about 4 percent by weight, based on total nonvolatile vehicle weight, of a melamine resin or up to about 3 percent by weight, based on total nonvolatile vehicle weight, of a melamine resin. The refinish coating composition is essentially free of any catalyst to promote reaction between the melamine resin and the polymeric polyol.

Nonlimiting examples of suitable melamine resins include monomeric and polymeric melamine formaldehyde resins and partially or fully alkylated melamine resin. A melamine resin may be obtained by reaction of the activated nitrogens of melamine with a lower molecular weight aldehyde with the product then further reacted with an alcohol to form an ether group. The aldehyde may be selected from formaldehyde, acetaldehyde, crotonaldehyde, benzaldehyde, or other aldehydes used in making aminoplast resins, although formaldehyde and acetaldehyde are, especially formaldehyde is, usually used. The activated nitrogen groups are at least partially alkylolated with the aldehyde, and may be fully alkylolated; in certain embodiments the activated nitrogen groups are fully alkylolated of the melamine formaldehyde resin. The reaction may be catalyzed by an acid, e.g. as taught in U.S. Pat. No. 3,082,180, the contents of which are incorporated herein by reference. The alkylol groups formed by the reaction of the activated nitrogen with aldehyde may be partially or fully etherified with one or more monofunctional alcohols. Suitable examples of the monofunctional alcohols include, without limitation, methanol, ethanol, propanol, isopropanol, butanol, isobutanol, tert-butyl alcohol, benzyl alcohol, and so on. Monofunctional alcohols having one to four carbon atoms and mixtures of these are preferred The etherification may be carried out, for example, by the processes disclosed in U.S. Pat. Nos. 4,105,708 and 4,293,692, the disclosures of which are incorporated herein by reference.

In certain embodiments the melamine resin is fully etherified, for example hexamethoxymethyl melamine, or a fully alkylated, mixed butylated, methylated melamine. The melamine formaldehyde resin may be monomeric or polymeric. In certain embodiments, the melamine formaldehyde included in the refinish composition is a monomeric, fully etherified melamine formaldehyde resin.

The melamine resin may be included in the first package, the second package, a reducer, or a combination of these. In one embodiment, the refinish, multi-component coating composition is a two-component clearcoat coating composition having a clear or transparent first package. In different versions of this embodiment, the melamine resin is included in the first package or the second package or in a reducer. If the melamine is included in a reducer, generally there is a plurality of reducers, one or more of which is selected to make the refinish coating composition mixture depending upon ambient application conditions, and melamine resin is included in each of the various reducers. In another embodiment, the refinish, multi-component coating composition is a multi-component monocoat coating composition having a plurality of differently colored bases containing pigment and hydroxyl-functional polymer as first components or packages, one or more of which is combined with the second package with polyisocyanates just prior to application. In certain embodiments, the melamine resin may be included in each of the colored bases and/or in each of one or more reducers.

The refinish composition may contain other materials, including additives such as pigments (in the case of monocoat color bases), flow additives or rheology control agents, surfactants, stabilizers, light stabilizers such as UV absorbers and hindered amine light stabilizers, and so on. Curing catalysts for the urethane reaction such as tin catalysts can be used in the coating composition. Typical examples are without limitation, tin and bismuth compounds including dibutyltin dilaurate, dibutyltin oxide, and bismuth octoate. When used, catalysts are typically present in amounts of about 0.05 to 2 percent by weight tin based on weight of total nonvolatile vehicle.

The pigment or filler may be any organic or inorganic compounds or colored materials, metallic or other inorganic flake materials such as pearlescent mica flake pigments or metallic flake pigments such as aluminum flake, and other materials of kind that the art normally includes in such coatings. Pigments and other insoluble particulate compounds such as fillers are usually used in the refinish monocoat composition mixture in an amount of 1% to 100%, based on the total nonvolatile vehicle (i.e., a pigment-to-binder ratio of 0.1 to 1). The fillers or pigments can be introduced by first forming a mill base with the hydroxyl functional resin or with other compatible polymers or dispersing resins by conventional techniques, such as sandgrinding, ball-milling, attritor grinding, two roll milling to disperse the pigments.

The refinish clearcoat or monocoat topcoat of the invention is applied in a layer to a desired area of the substrate to be refinished and cured. The clearcoat is applied over an applied basecoat layer. The basecoat layer is allowed to dry before the clearcoat composition is applied. The clearcoat composition is then cured, at ambient or low temperature bake conditions.

The refinished substrate may be an automotive vehicle or a component of an automotive vehicle. The refinish coating compositions may, however, be applied to other articles for which a protective and/or decorative coating is desirable. Such articles may be those having parts or substrates that cannot withstand high temperature curing conditions or that cannot easily be placed in a high-bake oven.

The invention is further described in the following example and comparative example. The examples are merely illustrative and do not in any way limit the scope of the invention as described and claimed. All parts are by weight unless otherwise indicated.

### Example of the Invention and Comparative Example

A two-component clearcoat refinish coating composition of the invention and a comparative example were prepared by first separately preparing the following First component, Second component, Reducer of the Invention, and Comparative Reducer.

First Component:

TABLE 1

| parts | parts | | | | Hydroxyl |
|---|---|---|---|---|---|
| by | by | | | | Equivalent |
| weight | volume | Description | % NV | #/gal | Weight |
| 2.935 | 3.235 | Xylene | 0.00% | 7.252 | |
| 79.976 | 78.257 | Acrylic resin | 55.00% | 8.170 | 434 |
| 1.145 | .981 | Plasticizer | 100.00% | 9.326 | |
| 3.475 | 3.669 | First flow | 22.55% | 7.572 | 1133 |
| | | additive | | | |
| | | solution | | | |
| 1.617 | 1.504 | Light | 97.05% | 8.595 | |
| | | stabilizer | | | |
| | | additive | | | |
| .024 | .022 | Catalyst | 100.00% | 8.743 | |
| | | Second flow | | | |
| .402 | .397 | additive | 76.00% | 8.105 | |
| | | solution | | | |
| 2.983 | 3.015 | Ethyl 3- | 0.00% | 7.910 | |
| | | Ethoxy- | | | |
| | | proprionate | | | |
| | | 99% | | | |
| .198 | .144 | Acid catalyst | 100.00% | 10.992 | |
| 7.044 | 8.533 | Acetone | 0.00% | 6.600 | |

Second Component:

TABLE 2

| | | | | | —NCO |
|---|---|---|---|---|---|
| parts by | parts by | | | | Equivalent |
| weight | volume | Description | % NV | #/gal | Weight |
| 13.6 | 16.416 | Normal Butyl | 0.00% | 7.350 | |
| | | Acetate 99% | | | |
| 13.5 | 16.520 | Toluene 99.7% | 0.00% | 7.250 | |
| | | Min | | | |
| 0.9 | 1.076 | Catalyst solution | 9.91% | 7.423 | |
| 72.0 | 65.989 | Polyisocyanate | 100.00% | 9.680 | 186 |
| | | crosslinker | | | |

Reducer of the Invention

TABLE 3

| parts | | | | |
|---|---|---|---|---|
| by | parts by | | | |
| weight | volume | Description | % NV | #/gal |
| 19.334 | 22.970 | NAPHTHA | 0.00% | 6.495 |
| | | ALIPHATIC | | |
| | | (MINERAL SPIRITS) | | |
| 2.417 | 2.539 | SOLVESSO 100 | 0.00% | 7.344 |
| | | 175 KG | | |
| 21.751 | 22.836 | Normal Butyl | 0.00% | 7.350 |
| | | Acetate 99% | | |
| 3.222 | 3.505 | Diptentene | 0.00% | 7.093 |
| 26.584 | 25.547 | Propylene glycol | 0.00% | 8.030 |
| | | monomethyl | | |
| | | ether acetate. | | |
| 7.250 | 7.136 | Ethylene glycol butyl | 0.00% | 7.840 |
| | | ether acetate. | | |
| 19.442 | 15.466 | RESIMENE CE-7103 | 100.00% | 9.700 |
| | | (Hexamethoxymethyl/ | | |
| | | n-butyl-melamine | | |
| | | formaldehyde resin, | | |
| | | available from Ineos | | |
| | | Melamines Inc.) | | |

Comparative Reducer

TABLE 4

| parts | parts | | | |
|---|---|---|---|---|
| by | by | | | |
| weight | volume | Description | % NV | #/gal |
| 16.002 | 18.027 | HI FLASH VMP NAPHTHA | 0.00% | 6.466 |
| 5.892 | 5.844 | SOLVESSO 100 175 KG | 0.00% | 7.344 |
| 62.085 | 61.529 | Normal butyl acetate 99% | 0.00% | 7.350 |
| 13.018 | 11.809 | Propylene glycol monomethyl | 0.00% | 8.030 |
| | | ether acetate. | | |
| 3.003 | 2.790 | Ethylene glycol butyl ether | 0.00% | 7.840 |
| | | acetate. | | |

The Example of the Invention clearcoat composition was prepared by thoroughly mixing together 4 parts by volume of the first component and 1 part by volume of the second component, then combining the mixture with 1 part by volume of the Reducer of the Invention.

The Comparative Example clearcoat composition was prepared by thoroughly mixing together 4 parts by volume of the first component and 1 part by volume of the second component, then combining the mixture with 1 part by volume of the Comparative Reducer.

Test panels were prepared by spray applying each of the clearcoat compositions to 4×12 inch test panels (unless otherwise instructed due to ASTM instructions). The test panels were CRS (cold rolled steel) commonly used in paint testing. The panels were prepared by cleaning with a degreasing wipe, sanding with P400 sand paper on a pneumatic sander, re-cleaning with a final wipe cleaner and drying. Then, a standard etch primer and high build urethane primer were applied. After 24 hours flash, the primer was sanded with P400 and a lacquer-type red basecoat was applied. After the basecoat flashed for 20 minutes, the clearcoat composition was prepared as described above and applied to achieve a dry film build of 2.0-2.5 mils.

The following tests were run on the prepared panels to compare the Example of the Invention with the Comparative Example.

Chemical etch testing was carried out using a Film Forming Gradient Temperature Bar (59° C.-81° C.) The following solutions were tested on the prepared panels: Solutions of sulfuric acid (H₂SO₄) adjusted to pH of 2, 3, and 4; 0.5% phosphoric acid; hydrochloric acid of 0.4 N (c 0.2%); nitric acid of 0.1%; a solution in water of 0.75% CaSO₄ adjusted to a pH of 4; deionized water and tap water, bee dropping mixture (47 g formic acid, 24 g tannic acid 10% in water, 24 g honey, and 5 g albumin 10% in water). According to the test method, 0.05 mils of specified solutions were applied along the entire length of 2 test panels. The test panels were then placed on the gradient temperature bar (59° C.-81° C., calibrated for heat-up rate of 2 minutes or less). One panel was removed after 15 minutes temperature, the other after 30 minutes. Any remaining solution was rinsed off with water. The panels were examined for etching, discoloration, pitting, etc.

Results—both the Example of the Invention and the Comparative Example show very similar results after testing; however, after 7 days of recovery time, the Example of the Invention shows up to 75% recovery while the Comparative Example shows no recovery.

ASTM D-6037 Method B (Mar resistance). Results—both the Example of the Invention and the Comparative Example show very similar results after testing; however, after 7 days of recovery time, the Example of the Invention showed up to 85% recovery while the Comparative Example shows no recovery.

ASTM D-3170 (Stone shot testing). After testing, the control clear showed chip size of 3 mm while the inventions clear utilizing melamine reducer showed chip size of 1 mm. After 7 days recovery the Example of the Invention showed improvement in appearance while the Comparative Example shows no improvement.

ASTM D5031 (Accelerated weathering (SAE J1960) Exposure Time 3000 h).

TABLE 5

| Red Basecoat | Initial Gloss | 3000 hours |
|---|---|---|
| Panels | at 20° | exposure 20° |
| Comparative | 85.6° | 80.3° |
| Example | | |
| Example of | 84.2° | 86.1° |
| the Invention | | |

ASTM 1735 Method Humidity Testing and ASTM33359 Method B for Adhesion. (Scale reads 0B=complete failure to 5B=Perfect Adhesion)

TABLE 6

| Red Basecoat | Initial | 96 hours |
|---|---|---|
| Panels | Adhesion | exposure |
| Comparative | 5B | 3B |
| Example | | |
| Example of | 5B | 5B |
| the Invention | | |

ASTM 790 Flexible testing Method A. This test was conducted with no additional flexiblizing additives in the Examples.

TABLE 7

| Red Basecoat | Room | |
|---|---|---|
| Panels | Temp. | −17c |
| Comparative | No paint | Severe paint |
| Example | fracture | fracture |
| Example of | No paint | No paint |
| the Invention | fracture | fracture |

The invention has been described in detail with reference to preferred embodiments thereof. It should be understood, however, that variations and modifications can be made within the spirit and scope of the invention.

In practicing the refinish, multi-component compositions that have been described, the various features may be used in any combination. For example, the refinish, multi-component coating composition may optionally include a reducer or a plurality of reducers, and in various embodiments, melamine resin may be included in the first package, the second package, and/or one or more reducers. In all of these embodiments, more than one melamine resin may be employed and apportioned in any way among the first package, second package, and any reducer(s). In each case, the multi-component coating composition may be from about 2 to about 4 percent by weight, based on total nonvolatile vehicle weight, of the melamine resin. In each case the melamine resin may be a monomeric, fully alkylated melamine. Each of these features may be used in any combination whether the refinish compositions are clearcoat compositions or single stage topcoat (also known as monocoat topcoat) compositions, the latter for which the refinish, multi-component compositions would include one or more color bases. In all of the various embodiments, the first package(s), second package(s), and optional reducer(s) are combined to form a refinish coating composition mixture comprising from about 1 to about 4.5 percent by weight, based on total nonvolatile vehicle weight, of a melamine resin that is substantially unreactive toward the hydroxyl-functional polymer at temperatures up to about 60° C. then applied to a desired area of a substrate, and cured to form a cured refinish coating layer on the substrate.

A first refinish, multi-component coating composition comprises (a) a first package comprising a hydroxyl-functional polymer and (b) a second package comprising a polyisocyanate crosslinker, wherein the refinish, multi-component coating composition comprises from about 1 to about 4.5 percent by weight, based on total nonvolatile vehicle weight, of a melamine resin that is substantially unreactive toward the hydroxyl-functional polymer at temperatures up to about 60° C. A second refinish, multi-component coating composition is according to the first refinish, multi-component coating composition, wherein the first package may comprise the melamine resin. A third refinish, multi-component coating composition is according to the first or the second refinish, multi-component coating composition, wherein the second package comprises the melamine resin. A fourth refinish, multi-component coating composition is according to any one of the first, second, or third refinish, multi-component coating compositions, further comprising a reducer. A fifth refinish, multi-component coating composition is according to the fourth refinish, multi-component coating composition, wherein the reducer comprises the melamine resin. As already mentioned, the melamine resin may also be in the first package, the second package, or both the first and the second packages in the fifth refinish, multi-component coating composition. A sixth refinish, multi-component coating composition is according to the fourth or the fifth refinish, multi-component coating composition, wherein there is a plurality of reducers. A seventh refinish, multi-component coating composition is according to the sixth refinish, multi-component coating composition, wherein a plurality of reducers comprise the melamine resin. (Again, the first package, second package, or both may also comprise the melamine resin.) An eighth refinish, multi-component coating composition is according to any one of the first, second, third, fourth, fifth, sixth, or seventh refinish, multi-component coating compositions, wherein the multi-component coating composition comprises from about 2 to about 4 percent by weight, based on total nonvolatile vehicle weight, of the melamine resin. A ninth refinish, multi-component coating composition is according any one of the first, second, third, fourth, fifth, sixth, seventh, or eighth refinish, multi-component coating compositions, wherein the melamine resin is a monomeric, fully alkylated melamine. A tenth refinish, multi-component coating composition is according any one of the first, second, third, fourth, fifth, sixth, seventh, eighth, or ninth refinish, multi-component coating compositions, wherein the refinish, multi-component coating composition is a refinish, multi-component clearcoat coating composition. An eleventh refinish, multi-component coating composition is according any one of the first, second, third, fourth, fifth, sixth, seventh, eighth, or ninth refinish, multi-component coating compositions, wherein the refinish, multi-component coating composition is a refinish, multi-component monocoat coating composition comprising a plurality of first components that are color bases.

A first method of refinishing a substrate comprises (a) combining a first package comprising a hydroxyl-functional polymer, a second package comprising a polyisocyanate crosslinker, and optionally one or more reducers to form a refinish coating composition mixture, wherein the refinish coating composition mixture comprises from about 1 to about 4.5 percent by weight, based on total nonvolatile vehicle weight, of a melamine resin that is substantially unreactive toward the hydroxyl-functional polymer at temperatures up to about 60° C.; (b) applying the refinish coating composition mixture to a desired area of the substrate, and (c) curing the applied composition mixture to form a cured refinish coating layer on the substrate. A second method is according to the first method, wherein the refinish coating composition mixture is a clearcoat coating composition mixture. A third method is according to the first method, wherein the refinish coating composition mixture is a monocoat coating composition mixture. A fourth method is according any one of the first, second, or third methods, wherein the refinish coating composition mixture comprises from about 2 to about 4 percent by weight, based on total nonvolatile vehicle weight, of the melamine resin. A fifth method is according any one of the first, second, third, or fourth methods, wherein the melamine resin is a monomeric, fully alkylated melamine. A sixth method is according any one of the first, second, third, fourth, or fifth methods, wherein the applied composition mixture is cured under ambient conditions.

What is claimed is:

1. A refinish, multi-component coating composition comprising:
(a) a first package comprising a hydroxyl-functional polymer and
(b) a second package comprising a polyisocyanate crosslinker,
wherein the refinish, multi-component coating composition comprises from about 1 to about 4.5 percent by weight, based on total nonvolatile vehicle weight, of a melamine resin that is substantially unreactive toward the hydroxyl-functional polymer at temperatures up to about 60° C.

2. A refinish, multi-component coating composition according to claim 1, wherein the first package comprises the melamine resin.

3. A refinish, multi-component coating composition according to claim 1, wherein the second package comprises the melamine resin.

4. A refinish, multi-component coating composition according to claim 1, further comprising a reducer.

5. A refinish, multi-component coating composition according to claim 4, wherein the reducer comprises the melamine resin.

6. A refinish, multi-component coating composition according to claim 1, further comprising a plurality of reducers.

7. A refinish, multi-component coating composition according to claim 6, wherein a plurality of the reducers comprise the melamine resin.

8. A refinish, multi-component coating composition according to claim 1, wherein the multi-component coating composition comprises from about 2 to about 4 percent by weight, based on total nonvolatile vehicle weight, of the melamine resin.

9. A refinish, multi-component coating composition according to claim 1, wherein the melamine resin is a monomeric, fully alkylated melamine.

10. A refinish, multi-component coating composition according to claim 1, wherein the refinish, multi-component coating composition is a refinish, multi-component clearcoat coating composition.

11. A refinish, multi-component coating composition according to claim 1, wherein the refinish, multi-component coating composition is a refinish, multi-component monocoat coating composition comprising a plurality of first components that are color bases.

12. A method of refinishing a substrate, comprising:
(a) combining a first package comprising a hydroxyl-functional polymer, a second package comprising a polyisocyanate crosslinker, and optionally one or more reducers to form a refinish coating composition mixture, wherein the refinish coating composition mixture comprises from about 1 to about 4.5 percent by weight, based on total nonvolatile vehicle weight, of a melamine resin that is substantially unreactive toward the hydroxyl-functional polymer at temperatures up to about 60° C.;
(b) applying the refinish coating composition mixture to a desired area of the substrate, and
(c) curing the applied composition mixture to form a cured refinish coating layer on the substrate.

13. A method according to claim 12, wherein the refinish coating composition mixture is a clearcoat coating composition mixture.

14. A method according to claim 12, wherein the refinish coating composition mixture is a monocoat coating composition mixture.

15. A method according to claim 12, wherein the refinish coating composition mixture comprises from about 2 to about 4 percent by weight, based on total nonvolatile vehicle weight, of the melamine resin.

16. A method according to claim 12, wherein the melamine resin is a monomeric, fully alkylated melamine.

17. A method according to claim 12, wherein the applied composition mixture is cured under ambient conditions.
